(19) United States
(12) Patent Application Publication
(10) Pub. No.: US 2024/0210120 A1
(43) Pub. Date: Jun. 27, 2024

(54) ENERGY STORAGE SYSTEM AND DEVICE

(71) Applicant: Maersk A/S, Copenhagen K (DK)

(72) Inventor: Henrik BAK WEIMAR, Copenhagen K (DK)

(21) Appl. No.: 18/557,549

(22) PCT Filed: Apr. 29, 2022
(86) PCT No.: PCT/EP2022/061504

§ 371 Date: Oct. 26, 2023

(30) Foreign Application Priority Data
Apr. 30, 2021 (DK) PA202100448

(51) Int. Cl. F28D 20/02; B63J 2/12; F28D 20/00; F28D 21/00

(52) U.S. Cl. CPC F28D 20/023; B63J 2/12; F28D 20/021; B63J 2002/125; F28D 2020/0078; F28D 2021/008

(57) ABSTRACT

Disclosed is an energy storage system for a marine vessel, the energy storage system comprising a first fluid inlet to receive a first fluid from a first system of the marine vessel, and a second fluid outlet for supplying a second fluid to a second system of the marine vessel. The energy storage system further comprises a phase change material, having a melting temperature of greater than 0 C at atmospheric pressure, to receive and store heat energy from the first fluid received from the first system via the first fluid inlet and to supply the heat energy to the second fluid to be supplied to the second system via the second fluid outlet.

### TECHNICAL FIELD

The present invention relates to energy storage devices and energy storage systems for marine vessels.

### BACKGROUND

Marine vessels, such as container ships, have systems that require heat, such as for heating crew accommodation, water supplies, engines, fuel lines and/or fuel storage tanks of the marine vessel. The heat for such systems is typically generated by boilers and/or electrical power systems of the marine vessel, in some examples by consuming fuel.

### SUMMARY

A first aspect of the present invention provides an energy storage system for a marine vessel, the energy storage system comprising: a first fluid inlet to receive a first fluid from a first system of the marine vessel; a second fluid outlet for supplying a second fluid to a second system of the marine vessel; and a phase change material, having a melting temperature of greater than 0 C at atmospheric pressure, to receive and store heat energy from the first fluid received from the first system via the first fluid inlet and to supply the heat energy to the second fluid to be supplied to the second system via the second fluid outlet.

In this way, the marine vessel is able to scavenge existing heat from the marine vessel and use this heat to heat the second system. This may reduce a total energy consumption of the marine vessel, such as to reduce greenhouse gas emissions from the marine vessel.

In other words, the phase change material is not water. Optionally, the phase change material has a higher specific latent heat than water. That is, more heat energy is required to cause 1 kg of phase change material to change phase than that required to cause 1 kg of water to change phase. In this way, the energy storage system may be more versatile and compact than an energy storage system comprising water as a phase change material.

Optionally, the melting temperature of the phase change material is greater than 80 C at atmospheric pressure. Optionally, the melting temperature of the phase change material is equal to or less than 125 C at atmospheric pressure. Optionally, the phase change material is selected to have a melting temperature such that the phase change material changes phase from a solid to a liquid as it receives and stores heat energy from the first fluid.

Optionally, the energy storage system is configured to store heat energy from the first system during a voyage of the marine vessel. Optionally, the energy storage system is configured to supply the stored heat energy to the second system when the marine vessel is docked, such as during, or shortly before or after, a port stay. In this way, the marine vessel is able to heat the second fluid for the second system using the energy scavenged from the first system during the voyage, for example to avoid operating an engine to heat the second fluid for the second system during the port stay. This may reduce total energy consumption of the marine vessel, and reduce emissions emitted by the marine vessel, such as CO2 and other greenhouse gases during the port stay.

Optionally, the energy storage system comprises a first fluid inlet valve for selectively opening and closing the first fluid inlet, and comprises a second fluid outlet valve for selectively opening and closing the second fluid outlet.

In this way, it is possible to prevent the first and second fluids from mixing in the energy storage system. Additionally, it is possible to achieve better control of the heat transfer between the first and second fluids and the phase change material.

Optionally, the energy storage system is configurable in: a first configuration, wherein the first fluid inlet is open and the second fluid outlet is closed; and a second configuration, wherein the second fluid outlet is open and first fluid inlet is closed.

In this way, in the first configuration, heat is transferable from the first fluid to the phase change material, and in the second configuration, heat is transferable from the phase change material to the second fluid.

Optionally, the energy storage system comprises a chamber, wherein the first fluid inlet and the second fluid outlet are fluidically connected or connectable to the chamber.

In this way, the first and second fluids may pass through the chamber, in use.

Optionally, the energy storage system comprises a second fluid inlet to receive the second fluid from the second system. Optionally, in the first configuration, the second fluid inlet is fluidically isolated from the chamber. Optionally, in the second configuration, the second fluid inlet is fluidically connected to the chamber.

Optionally, the energy storage system comprises a first fluid outlet. Optionally, the first fluid outlet is to supply the first fluid to the first system.

Optionally, the energy storage system comprises a second fluid inlet valve for selectively opening and closing the second fluid inlet, and comprises a first fluid outlet valve for selectively opening and closing the first fluid outlet

Optionally, in the first configuration, the first fluid outlet is fluidically connected to the chamber. Optionally, in the second configuration, the first fluid outlet is fluidically isolated from the chamber.

Optionally, the energy storage system comprises a conduit through which a third fluid is flowable to transfer heat energy between the phase change material and one or both of the first and second fluids.

Optionally, the conduit is configured so that the third fluid receives heat energy from the first fluid and supplies the heat energy received from the first fluid to the phase change material, in use. Optionally, the conduit is configured so that the third fluid receives heat energy from the phase change material and supplies the heat energy received from the phase change material to the second fluid, in use.

In this way, the energy storage system may transfer heat between each of the first and second fluids and the phase change material via the third fluid. This may lead to greater physical isolation of the first and second systems. Such isolation may reduce a risk of the first and second fluids mixing, and/or improve an ease of maintenance of the energy storage system.

Optionally, the energy storage system comprises a first heat exchanger for exchanging the heat energy between the first fluid and the third fluid. Optionally, the energy storage system comprises a second heat exchanger for exchanging the heat energy between the third fluid and the second fluid.

Optionally, the energy storage system comprises a loop through which the third fluid is flowable. Optionally, the loop comprises the conduit. Optionally, the loop comprises the first and/or the second heat exchanger. Optionally, the energy storage system comprises a housing in which the phase change material is housed, and the loop is configured to pass the third fluid through the housing. Optionally, the energy storage system comprises a chamber in which the phase change material is located, and the loop comprises the chamber. Optionally, the energy storage system comprises a fluid loop bypass valve for causing the third fluid to bypass the first heat exchanger. Optionally, when the fluid loop bypass valve is open, the third fluid is passed through the fluid loop without receiving heat from the first system via the first heat exchanger.

Optionally, the energy storage system comprises a phase change capsule, the phase change capsule comprising the phase change material and a heat exchange interface encapsulating the phase change material.

Optionally, the energy storage system comprises a chamber and plural such phase change capsules arranged in the chamber so as to define plural fluid flow paths, between the phase change capsules, for flow of the third fluid or one or both of the first fluid and the second fluid in the chamber. Optionally, the energy storage system is configured so that the third fluid, or one or both of the first fluid and the second fluid, is passable through the chamber via the plural fluid flow channels.

In this way, the third fluid, or the one or both of the first fluid and the second fluid, may permeate through voids between the phase change capsules in the chamber, thereby to improve a contact area between the respective fluid and the phase change capsules, and so improve an efficiency of heat transfer between the respective fluid and the phase change capsules. In some examples, the encapsulating the phase change material ensures that a majority of the phase change material is able to change phase in the presence of the first fluid, the second fluid and/or the third fluid.

Optionally, the heat exchange interface comprises a polymeric material. Optionally, the heat exchange interface comprises a metallic or ceramic material. Optionally, the heat exchange interface comprises any other suitable thermally conductive material.

A second aspect of the present invention provides an energy storage device for a marine vessel, the energy storage device comprising: a housing; a first fluid inlet to receive a first fluid into the housing from a first system of the marine vessel; a second fluid outlet for supplying a second fluid from the housing to a second system of the marine vessel; and a phase change material in the housing to receive and store heat energy from the first fluid received into the housing via the first fluid inlet and to supply the heat energy to the second fluid to be supplied from the housing to the second system of the marine vessel via the second fluid outlet.

In this way, the first and second fluids are each passable through the housing, via the phase change material, such as at different times. This provides an efficient and compact arrangement for storing heat energy from the first system and supplying the heat energy to the second system at a later time.

Optionally, the energy storage device of the second aspect comprises any of the optional features of the energy storage system of the first aspect. For example, optionally, the energy storage device comprises a second fluid inlet to receive the second fluid into the housing from the second system of the marine vessel. Optionally, the energy storage device comprises a first fluid outlet to supply the first fluid from the housing to the first system of the marine vessel.

A third aspect of the present invention provides a hull for a marine vessel, the hull comprising at least one energy storage system according to the first aspect, or at least one energy storage device according to the second aspect.

Optionally, the energy storage system of the first aspect and/or the energy storage device of the second aspect is modular and compact. As such, the hull may advantageously comprise plural energy storage systems of the first aspect and/or plural energy storage devices of the second aspect.

A fourth aspect of the present invention provides a marine vessel comprising: the hull of the third aspect, the energy storage system of the first aspect, or the energy storage device of the second aspect; and the first system and the second system.

Optionally, the first system comprises a boiler system of the marine vessel. Optionally, the boiler system is configured to transfer heat energy from an exhaust gas of an engine of the marine vessel to the first fluid, thereby to supply the heat energy to the first fluid upstream of the first fluid inlet. Optionally, the first system comprises an intercooler system of the engine of the marine vessel. Optionally, the intercooler system is configured to transfer heat from the engine of the marine vessel to the first fluid, thereby to supply the heat energy to the first fluid upstream of the first fluid inlet.

Optionally, the second system is a heating system of the marine vessel. Optionally, the marine vessel comprises a fuel storage tank configured to store fuel, and the second system comprises a fuel tank heater arranged to heat fuel stored in the fuel storage tank in use. Optionally, the energy storage system and/or the energy storage device and/or the second system is configured to supply the second fluid to the fuel tank heater, so that the heat energy supplied to the second fluid by the phase change material is usable by the fuel tank heater to heat the fuel. The fuel may be heated to reduce a viscosity of the fuel.

In this way, the fuel stored in the fuel storage tank may be preheated prior to an upcoming voyage using heat stored in the energy storage system during a previous voyage, thereby reducing the emissions of the marine vessel, as noted hereinbefore.

A fifth aspect of the present invention provides a method of handling energy in a marine vessel, the method comprising: storing, in a phase change material having a melting temperature of greater than 0 C at atmospheric pressure, heat energy from a first fluid from a first system of the marine vessel; and supplying, to a second fluid for a second system of the marine vessel, the heat energy stored in the phase change material.

Optionally, the method comprises receiving the first fluid from the first system of the marine vessel. Optionally, the method comprises supplying, to the second system of the marine vessel, the second fluid heated by the heat energy stored in the phase change material.

Optionally, the method comprises storing the heat energy in the phase change material of the energy storage system of the first aspect. Optionally, the method comprises storing the heat energy in the phase change material of the energy storage device of the second aspect. Optionally, the marine vessel is the marine vessel of the fourth aspect

Optionally, the method comprises any of the optional features, and/or actions performed by the energy storage system of the first aspect and/or the energy storage device of the second aspect.

### BRIEF DESCRIPTION OF THE DRAWINGS

Embodiments of the invention will now be described, by way of example only, with reference to the accompanying drawings, in which:

FIG. 1 shows a schematic side view of an example of a marine vessel according to an example;

FIG. 2 shows a schematic view of an energy storage system according to an example;

FIG. 3a shows a schematic view of an energy storage device according to an example;

FIG. 3b shows a schematic view of an energy storage device according to another example;

FIG. 4 shows a schematic view of an energy storage system according to another example; and

FIG. 5 shows a flow chart of a method according to an example.

### DETAILED DESCRIPTION

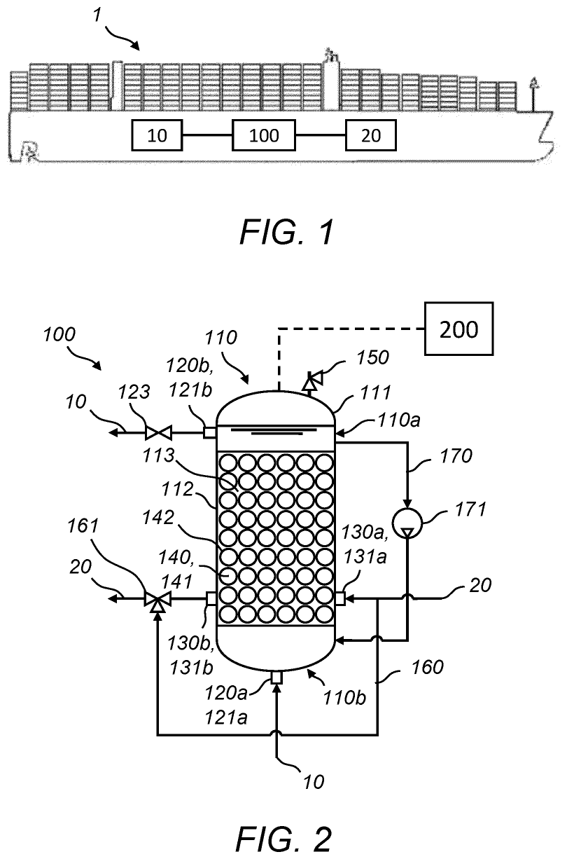

FIG. 1 shows a schematic side view of an example of a marine vessel 1 according to an example. In this example, the marine vessel 1 is a container ship 1. In other embodiments, the marine vessel 1 is another form of cargo vessel, such as a tanker, a dry-bulk carrier or a reefer ship, or a passenger vessel or any other marine vessel, such as a tugboat.

The marine vessel 1 comprises an energy storage system 100, a first system 10 and a second system 20. The energy storage system 100 is configured to receive and store heat energy from the first system 10, and to supply the stored heat energy to the second system 20. The marine vessel 1 further comprises a hull 2. The hull 2 comprises the energy storage system 100. The energy storage system 100 is located in an engine room of the marine vessel 1, but in other examples may be located in any suitable place in the hull 2 or elsewhere in the marine vessel 1.

In the illustrated example, the first system 10 comprises a boiler configured to extract heat from an exhaust gas of an engine of the marine vessel 1. The first system comprises a first fluid, specifically water in this example, and is configured so that the water is heated in the boiler by the exhaust gas from the engine. In this example, the heated water is converted into steam, which is then passed to the energy storage system 100. The steam may be unsaturated (wet) steam, saturated (dry) steam, or superheated steam. In this way, the heat energy from the first system 10, specifically from the boiler, is transferred, via the first fluid, to the energy storage system 100 to be stored in the energy storage system 100.

In the illustrated example, the second system 20 comprises a heater configured to heat fuel stored in a fuel storage tank of the marine vessel. The second system comprises a second fluid, specifically water in this example, and is configured so that the water is heated by the heat energy stored in the energy storage system 100. In this way, the heat energy stored in the energy storage system 100 is transferred, via the second fluid, to the second system, specifically to the heater.

The first system 10 and the second system 20 comprise respective first and second fluid pumps (not shown) for pumping the respective first and second fluids to/from the energy storage system 100. In other examples, the first fluid pump and/or the second fluid pump is comprised in the energy storage system 100.

The first and second systems are fluidically coupled in respective first and second loops with an energy storage device 110 of the energy storage system 100, as will be described in more detail below. In this way, the first fluid flows from the first system, to the energy storage device, and back to the first system. In other examples, the first fluid flows from the first system to the energy storage device and then to another system of the marine vessel, such as the second system, a heating system, or another energy storage system, or is supplied to a drain. Similarly, in the illustrated example, fluid flows from the second system, to the energy storage system, and back to the second system. In other examples, the second fluid is received from another system of the marine vessel, such as from the first system, from another energy storage system, or from any other suitable source.

In some examples, the energy storage system 100 is configured to store heat energy from the first system during a voyage of the marine vessel, such as when the engine is in use. In some examples, the energy storage system 100 is configured to supply the stored heat energy to the second system 20 when the marine vessel 10 is docked, such as during a port stay. That is, the energy storage system 100 may store waste heat generated during a voyage for use during a port stay. In this way, the marine vessel 10 may consume less fuel and/or emit fewer emissions than if it were to supply heat energy to the second system 20 in another way, such by operating the engine or coupling the marine vessel to an external power supply during the port stay.

It will be appreciated that, in other examples, the first system 10 comprises any other suitable heat source and the second system 20 comprises any suitable heat sink. In some examples, the first system comprises a cooling system of the engine, such as an air cooler or intercooler of the engine. In some examples, the second system comprises a hotel load of the marine vessel, such as a heating system for heating one or more crew facilities of the marine vessel.

Turning now to FIG. 2, shown is a first example of the energy storage system 100. A second example of the energy storage system 100 is shown and described hereinafter, with reference to FIG. 4.

The energy storage system 100 of the present example comprises the energy storage device 110 briefly referred to above. The energy storage device 110 comprises a housing 111, a chamber 112 in the housing 111, and a phase change material 140 in the chamber 112. In the present example, the phase change material 140 is encapsulated in plural phase change capsules 141. The plural phase change capsules 141 are arranged in the chamber 112 to define plural fluid flow channels 113 between the phase change capsules 141. In this way, a fluid flowing through the chamber 112 is passable along the plural fluid flow channels 113. In other examples, the phase change material 140 may be provided in the housing 111 in a different way or form.

The energy storage device 110 comprises a first fluid inlet 120a and a second fluid inlet 130a into the housing 111. The first fluid inlet 120a is configured to receive the first fluid into the housing 111 from the first system 10, and the second fluid inlet 130a is configured to receive the second fluid into the housing 111 from the second system 20. Specifically, the first fluid inlet 120a and the second fluid inlet 130a each open into the chamber 112, in the present example. More specifically, the energy storage system 100 comprises a first fluid inlet valve 121a and a second fluid inlet valve 131a for selectively fluidically coupling the first fluid inlet 120a and the second fluid inlet 130a respectively to the chamber 112.

In some examples, the energy storage system 100 comprises a controller 200 communicatively coupled to the energy storage system 100, such as to the energy storage device 110, or components thereof. The controller 200 is operable by a user, or automatically, such as based on one or more criteria being met, to cause the first fluid inlet valve 121a and the second fluid inlet valve 131b to selectively open and close the first fluid inlet 120a and the second fluid inlet 130a respectively. In some examples, the one or more criteria comprise any one or more of: a status of the marine vessel 1, such as whether the marine vessel 1 is sailing or stationary; a temperature of fluid and/or the phase change material 140 in the energy storage device 110; a temperature of the first fluid received from the first system 10; and a current and/or desired temperature of the second fluid supplied to the second system 20 from the energy storage device 110.

The energy storage device 110 also comprises a first fluid outlet 120b and a second fluid outlet 130b. The first fluid outlet 120b is configured to pass the first fluid from the energy storage device 110 to the first system 10, and the second fluid outlet 130b is configured to pass the second fluid from the energy storage device 110 to the second system 20. In the present example, the energy storage system 100 comprises a first fluid outlet valve 121b and a second fluid outlet valve 131b operable to selectively open and close the first fluid outlet 120b and the second fluid outlet 130b. In the present example, the first and second fluid outlet valves 121b and 131b are caused to open and close by the controller 200 as described hereinbefore with reference to the first and second fluid inlet valves 121a, 131a.

In other examples, the first fluid inlet valve 121a, the first fluid outlet valve 121b, the second fluid inlet valve 131a, and/or the second fluid outlet valve 131b is not present. In some such examples, the first and second fluid inlets 121a, 131a and outlets 121b 131b are always fluidically coupled to the chamber 112, or are selectively fluidically couplable to the chamber 112 in any other way.

In the present example, the energy storage device 110 is configurable in a first configuration, in which the first fluid inlet 120a and the first fluid outlet 120b are each fluidically coupled to the chamber 112, and the second fluid inlet 130a and the second fluid outlet 130b are each fluidically isolated from the chamber 112. In this way, in the first configuration, the first fluid is flowable through the fluid flow channels 113 between the phase change capsules 141 in the chamber 112 from the first fluid inlet 120a to the first fluid outlet 120b. The second fluid is unable to flow through the chamber 112 from the second fluid inlet 130a to the second fluid outlet 130b when the energy storage device 110 is in the first configuration.

The energy storage device 110 is also configurable in a second configuration, in which the second fluid inlet 130a and the second fluid outlet 130b are each fluidically coupled to the chamber 112, and the first fluid inlet 120a and the first fluid outlet 120b are each fluidically isolated from the chamber 112. In this way, in the second configuration, the second fluid is flowable through the fluid flow channels 113 between the phase change capsules 141 in the chamber 112 from the second fluid inlet 130a to the second fluid outlet 130b. The first fluid is unable to flow through the chamber 112 from the first fluid inlet 120a to the first fluid outlet 120b when the energy storage device 110 is in the second configuration.

In the first and second configurations, the respective first and second fluids are able to permeate between the phase change capsules 141, in use, to exchange heat energy between the respective first and second fluids and the phase change material 140. In the illustrated example, the energy storage device 110 is configurable separately in the first and second configurations, to reduce or eliminate mixing between the first and second fluids. In other examples, the first and second fluids can mix in the housing 111, such as in the chamber 112.

Each of the phase change capsules 141 comprises the phase change material 140 encapsulated by a heat exchange interface 142. In this way, a greater surface area of phase change material may be in (indirect) contact with the first and second fluids, leading to improved heat transfer properties. Moreover, there may be no, or less, contamination of the phase change material 140 by the first and second fluids, and/or less contamination of the first and second fluids by the phase change material 140.

In the illustrated examples the phase change material 140 is encapsulated in a spherical heat exchange interface 142 to form a spherical phase change capsule 141 containing the phase change material 140. In some examples, the spherical phase change capsule 141 is formed by encapsulating the phase change material 140 between two hemispherical shells defining the heat exchange interface 142. The hemispherical shells may be crimped, welded, bonded, fastened or otherwise held together in any other suitable way, to contain the phase change material 140 in the phase change capsule 141. In some examples, the phase change capsules 140 are sealed, so that the phase change material 140 is unable to make contact with, and/or mix with the first and second fluids in use. In other examples, the phase change capsules 141 are unsealed.

In other examples, the phase change material is encapsulated in a cylindrical heat exchange interface 142 to form cylindrical phase change capsules 141. In other examples, the phase change capsules 141 are any other suitable shape, such as disc-shaped, torus-shaped, ovular, or multi-faceted. In other examples, the phase changes capsules 141 do not comprise a heat exchange interface that is discrete from the phase change material. That is, in some examples, the first and second fluids may directly contact the phase change material in use.

The phase change material in the present example has a melting temperature of greater than 0 C (zero degrees centigrade) at atmospheric pressure. That is, in the present example, the phase change material is neither water, nor water mixed with an anti-freeze. More specifically, the phase change material in the present example has a melting temperature of greater than 80 C, such as between 80 C and 125 C, at atmospheric pressure.

In the present example, the first fluid is steam and the second fluid is water. The steam is supplied to the energy storage device 110 from the first system 10, which in this example comprises a boiler, at a temperature of greater than 125 C, such as between 130 C and 150 C. In the first configuration, the steam enters the housing 111 via the first fluid inlet 120a and supplies heat energy to the phase change material 140 as the steam flows through the energy storage device 110. The phase change material 140, having a melting temperature less than that of the first fluid, changes phase from a solid phase to a liquid phase as it receives the heat energy from the first fluid. In other words, the phase change material 140 stores heat energy from the first fluid in the form of latent heat. In other examples, the phase change material is in a liquid phase or a solid phase, and heat received from the first fluid causes the phase change material to increase in temperature without changing phase.

The first fluid exits the housing 110 via the first fluid outlet 120b at a lower temperature than when it entered the housing 111. It will be appreciated that the temperature of the first fluid leaving the housing 111 depends on numerous factors, such as the amount of heat that is stored as latent heat in the phase change material 140, the amount of phase change material 140 in the chamber 112, and the flow rate of the first fluid through the chamber 112. In some examples, the steam condensates in the housing 111, and exits the housing 111 as water, or saturated steam.

The second fluid, water, is supplied to the energy storage device 110 from the second system 20, which here comprises a fuel storage tank heater, at a temperature of less than 80 C, such as between 50 C and 80 C. In the second configuration, the water enters the housing 111 via the second fluid inlet 130a and receives the heat energy stored in the phase change material 140. The phase change material 140, having a melting temperature greater than that of the second fluid, changes phase from a liquid to a solid as it supplies heat energy to the second fluid. In other examples, the phase change material is in a liquid phase or a solid phase, and heat supplied to the second fluid from the phase change material causes the phase change material to decrease in temperature without changing phase.

The second fluid exits the housing 110 via the second fluid outlet 130b at a higher temperature than when it entered the housing 111. In the present example, the second fluid exits the housing at greater than 85 C, such as greater than 90 C, in order to heat fuel stored in the fuel storage tank. It will be appreciated, however, that the temperature of the second fluid leaving the housing 111 depends on numerous factors, such as the amount of heat that is stored as latent heat in the phase change material 140, the amount of phase change material 140 in the chamber 112, and the flow rate of the second fluid through the chamber 112, as set out hereinbefore.

In other examples, the steam and water (or other first and second fluids) are supplied to, and received from, the energy storage device 110 at any other suitable temperatures, depending on the particular application. It will be appreciated that, in any event, the phase change material is any suitable material having a melting temperature that is between the respective temperatures of the first and second fluids supplied to the energy storage device 110. In this way, the phase change material case change phase from a solid phase to a liquid phase in the presence of the first fluid received from the first system 10, thereby storing energy from the first fluid in the form of latent heat. The phase change material can then change phase from the liquid phase to the solid phase in the presence of the second fluid, thereby releasing the stored latent heat to the second fluid supplied to the second system 20. In some examples, the phase change material 140 can receive the heat energy from, and supply the heat energy to, the respective first and second fluids without undergoing a change in phase.

In the illustrated example, the energy storage system 100 comprises a second fluid bypass conduit 160 and a second fluid bypass valve 161, which here is a three-way valve, through which the second fluid is passable. The second fluid bypass valve 161 is operable to permit some, or all, of the second fluid to bypass the chamber 112, the housing 111, and/or the energy storage device 110 via the second fluid bypass conduit 160. In this way, the second fluid may be circulated within the second system 20 without being heated by heat stored in the energy storage device 110. In other examples the second fluid exiting the housing 111 from the second fluid outlet 130b may be mixed with the second fluid supply from the second system 20 via the second fluid bypass valve 161. This allows a more accurate control of the temperature of the second fluid supplied from the energy storage system 100 to the second system 20. In other examples, the second fluid bypass conduit 160 and the second fluid bypass valve 161 may be omitted.

The energy storage system 100 further comprises a first fluid supply valve 123 for controlling the first fluid exiting the housing 110. The first fluid supply valve 123 may, for example, be closed to contain steam inside the housing 111, and in contact with the phase change material 140, for a longer period. This may allow more heat to be passed from the steam, or other first fluid, to be stored in the phase change material 140 in the first configuration. The first fluid supply valve 123 may then be opened to allow the steam to exit the housing 111. In some examples, the first fluid supply valve 123 is operable by the controller 200. In other examples, the first fluid outlet valve 121b comprises the first fluid supply valve 123.

A temperature gradient may be present in the phase change material, and/or the first and/or second fluids present in the energy storage device 110 at any given time. Specifically, a higher temperature may be present in an upper portion 110a of the energy storage device 110 than in a lower portion 110b of the energy storage device 110. As such, the energy storage device comprises a recirculation conduit 170 and recirculation pump 171 for passing water, or steam, which may be at a temperature of between 90 C and 150 C in the energy storage device 110, from the upper portion 110a to the lower portion 110b. In this way, the recirculation conduit 170 and recirculation pump 171 may reduce a temperature difference between the upper and lower portions 110a, 110b of the energy storage device, in use. In other examples, the recirculation conduit 170 and the recirculation pump 171 may be omitted.

Finally, the energy storage device 110 shown in FIG. 2 comprises a pressure relief valve 150 for controlling a pressure in the housing 111 and/or the chamber 112. In other examples, the pressure relief valve 150 may be omitted. The energy storage device 110 also comprises a void fraction to allow for thermal expansion of the phase change material 140, such as the phase change capsules 141, or the first and/or second fluids in the housing 111. The void fraction may be separated from the chamber 112 by a membrane, or other suitable separator.

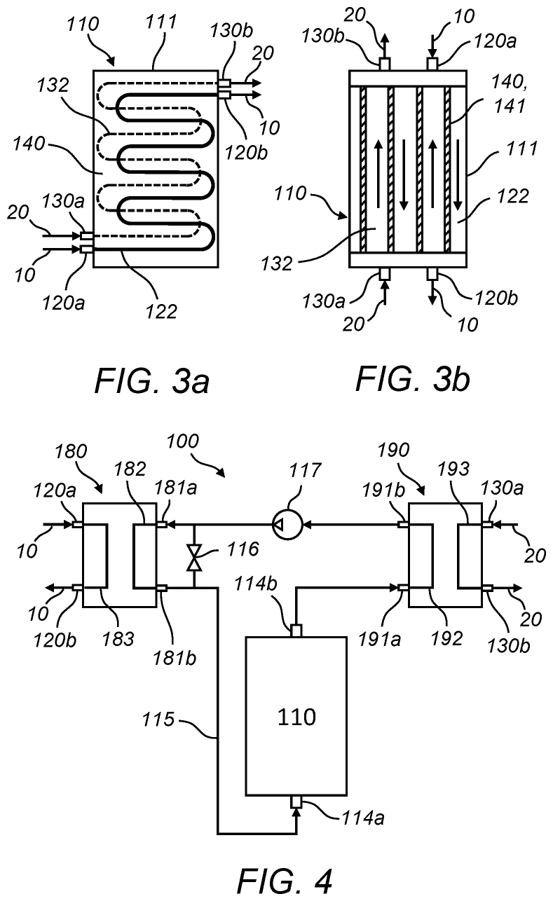

Turning briefly to FIGS. 3a and 3b, shown and described are two alternative examples of the energy storage device 110, in which like components are given like numerals. The example shown in FIG. 3a differs from that shown in FIG. 2 in that the phase change material 140 of the energy storage device of FIG. 3a is unencapsulated. That is, the phase change material 140 is provided in the housing 111 as a block of phase change material 140. In this example, there is no chamber 112, and no fluid flow channels 113 between phase change capsules 141. Instead, the first fluid is received from the first system 10 via the first fluid inlet 120a and passed to the first fluid outlet 120b via a first fluid conduit 122, which passes through the phase change material 140 in a circuitous path. Similarly, the second fluid is received from the second system 20 via the second fluid inlet 130a and passed to the second fluid outlet 130b via a second fluid conduit 132, which passes through the phase change material 140 in a circuitous path.

It will be appreciated that the first and second fluid conduits 122, 132 comprise any suitable heat exchange interface between the phase change material and the respective first and second fluids flowable therethrough, as described hereinbefore with reference to the phase change capsules 141 of FIG. 2. In the example shown in FIG. 3a, the phase change material 140 may be subject to a “candlelight effect”, whereby only the phase change material 140 that is near to the first fluid conduit 122 is melted as the first fluid is passed through the first fluid conduit. Similarly, only the phase change material 140 that is near to the second fluid conduit 132 may be solidified as the second fluid is passed through the second fluid conduit 122. Providing additional first and second fluid conduits 122, 132 fluidically coupled between respective first and second fluid inlets 120a, 130a and outlets 120b, 130b, such as by respective headers (not shown), may lead to improved heat transfer characteristics between the first and second fluids and the phase change material 140. Alternatively, or in addition, more efficient heat transfer characteristics may be achieved by providing first and second fluid conduits 122, 132 that take more tortuous paths through the phase change material 140. In such examples, however, an increased pressure drop may be seen across the energy storage device 110, and thereby larger pumps for pumping the first and second fluids may be required.

FIG. 3b shows another alternative energy storage device 110. Here, the housing 111 comprises plural fluid flow channels 122, 132, or chambers 122, 132, separated by columns of phase change material 140. Specifically, the energy storage device 110 comprises plural parallel first fluid flow channels 122 configured to pass the first fluid from the first fluid inlet 120a to the first fluid outlet 120b, and plural parallel second fluid flow channels 132 configured to pass the second fluid from the second fluid inlet 130a to the second fluid outlet 130b. The phase change material 140 in each column is separated from the first and second fluid channels 122, 132 by a heat exchange interface 142, as described hereinbefore.

In each of the examples shown in FIGS. 3a and 3b, the first and second fluids are not permitted to mix within the energy storage device 110. In either case, the first and second fluids may be passed through the energy storage device 110 simultaneously, which may permit a more direct heat transfer from the first fluid to the second fluid via the phase change material 140. Other types of energy storage device 110, further to those presented herein, will be evident to the skilled reader.

Turning now to FIG. 4, shown and described is an alternative energy storage system 100. The energy storage system 100 comprises an energy storage device 110, which is any of the energy storage devices 110 shown and described hereinbefore with reference to any one of FIGS. 2 to 3b, or any other suitable energy storage device comprising a phase change material 140. In FIG. 4, however, the energy storage device 110 has a single energy storage device inlet 114a and a single energy storage device outlet 114b for passing fluid respectively into and out of the housing 111.

In contrast to the energy storage system 100 of FIG. 2, the energy storage system 100 of FIG. 4 is configured to transfer heat energy between the first and second systems 10, 20 and the phase change material 140 in the energy storage device 110 indirectly, via a third fluid. Specifically, the energy storage system 100 comprises a first heat exchanger 180, a second heat exchanger 190 and a fluid conduit 115. The first and second heat exchangers 180, 190 are any suitable fluid-to-fluid heat exchangers. The energy storage system 100 also comprises a fluid loop comprising the fluid conduit 115, the energy storage device 110, the first and second heat exchangers 180, 190 and a third fluid pump 117 for pumping the third fluid around the fluid loop.

The first heat exchanger 180 comprises the first fluid inlet 120a and the first fluid outlet 120b of the energy storage system 100 for respectively receiving the first fluid from, and supplying the first fluid to, the first system 10. The first heat exchanger 180 comprises a first heat exchanger flow path 183 for passing the first fluid through the first heat exchanger 180 from the first fluid inlet 120a to the first fluid outlet 120b. The first heat exchanger 180 also comprises a first heat exchanger inlet 181a for receiving the third fluid into the first heat exchanger 180 from the third fluid pump 117, a first heat exchanger outlet 181b for supplying the third fluid from the first heat exchanger 180 to the energy storage device 110, and a first heat exchanger loop conduit 182 for passing the third fluid from the first heat exchanger inlet 181a to the first heat exchanger outlet 181b in the fluid loop. In this way, the first heat exchanger 180 is configured to transfer heat energy between the first fluid in the first heat exchanger flow path 183 and the third fluid in the first heat exchanger loop conduit 182.

In a similar way, the second heat exchanger 190 comprises the second fluid inlet 130a and the second fluid outlet 130b of the energy storage system 100 for respectively receiving the second fluid from, and supplying the second fluid to, the second system 20. The second heat exchanger 190 comprises a second heat exchanger flow path 193 for passing the second fluid through the second heat exchanger 190 from the second fluid inlet 130a to the second fluid outlet 130b. The second heat exchanger 190 also comprises a second heat exchanger inlet 191a for receiving the third fluid into the second heat exchanger 190 from the energy storage device 110, a second heat exchanger outlet 191b for supplying the third fluid from the second heat exchanger 190 to the third fluid pump 117, and a second heat exchanger loop conduit 192 for passing the third fluid from the second heat exchanger inlet 191a to the second heat exchanger outlet 191b in the fluid loop. In this way, the second heat exchanger 180 is configured to transfer heat energy between the third fluid in the second heat exchanger loop conduit 192 and the second fluid in the second heat exchanger flow path 193.

In this way, the third fluid transfers heat energy from the first fluid, received via the first heat exchanger 180, to the energy storage device 110. The energy storage device 110 receives and stores the energy from the third fluid. The third fluid then passes through the second heat exchanger 190, where it transfers its heat to the second fluid in the second heat exchanger 190.

The energy storage system 100 comprises a fluid loop bypass valve 116 for causing the third fluid to bypass the first heat exchanger 180. In this way, the energy storage system is configurable in a storage configuration, wherein the fluid loop bypass valve 116 is closed and the energy storage device 110 receives and stores heat from the first system 10 via the first heat exchanger 180. In the storage configuration, the third fluid may also supply residual heat in the fluid after it has passed through the energy storage device 110 to the second system 20, such as to heat fuel in a fuel storage tank during a voyage. The energy storage system 100 is also configurable in a supply configuration, wherein the fluid loop bypass valve 116 is open, and the third fluid is passed through the fluid loop without receiving heat from the first system 10 via the first heat exchanger 180. That is, in the supply configuration, the energy storage system is configured to supply heat stored in the energy storage device 110 to the second system 20, such as during a port stay.

It will be appreciated that, in some examples, the energy storage system 100 may comprise a second fluid loop bypass valve (not shown) for causing the third fluid to bypass the second heat exchanger 190. Moreover, in some examples, the third fluid pump 117 may be located elsewhere in the fluid loop, and/or the third fluid may be pumped around the fluid loop in the opposite direction. In some examples, the third fluid is maintained at a pressure of between 3 bar and 5 bar. In other examples, the third fluid pressure is outside of this range.

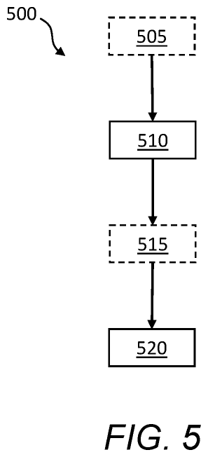

FIG. 5 shows an example method 500 of handling energy in the marine vessel 1. The method 500 comprises storing 510, in the phase change material 140, the heat energy from the first fluid from the first system 10 of the marine vessel 1. The method 500 further comprises supplying 520, to the second fluid for the second system 20 of the marine vessel 1, the heat energy stored in the phase change material 140.

The method 500 of the illustrated example also comprises receiving 505 the first fluid from the first system of the marine vessel and supplying 515, to the second system of the marine vessel, the second fluid heated by the heat energy stored in the phase change material 140. In some examples, the method 500 is performed by any one of the energy storage systems 100 described herein. As such, in some examples, the method 500 comprises any of the actions performed by any one of the energy storage systems 100 and/or energy storage devices 110 described herein.

It will be understood that the phase change material 140 in any of the examples described herein is any suitable phase change material 140. In some examples, the phase change material 140 is an organic phase change material 140, such as comprising either a paraffinic compound or a non-paraffinic compound. In other examples, the phase change material 140 is an inorganic phase change material 140, such as comprising a salt hydrate, or a metallic compound. In some examples, the phase change material 140 is a eutectic phase change material 140, which has a melting point lower than that of each of its constituent parts. In some examples, the eutectic phase change material is a combination of two or more organic phase change materials, two or more inorganic phase change materials, or an inorganic and an organic phase change material.

In some examples, the energy storage device 110 of any one of the examples described herein comprises a composite material comprising the phase change material 140. In some such examples, the composite material comprises a support structure containing the phase change material 140. In some examples, the support structure comprises a heat exchange interface 142 for exchanging heat between the phase change material 140 and the first, second and/or third fluids. In other examples, the composite material is a form-stable composite material comprising the phase change material 140. In some such examples, the first, second and or third fluid may be passed through the housing 111 in direct contact with the form-stable composite material.

It will also be appreciated that, although the housing 111 is shown in FIG. 2 as being generally cylindrical in shape, in other examples the housing 111 may take any other suitable shape. Similarly, the first and second heat exchangers 180, 190 may be any suitable shape, and the first and second heat exchanger loop conduits 182, 192 and the first and second heat exchanger flow paths 183, 193 may take any suitable path through the respective first and second heat exchangers 180, 190.

Embodiments of the present invention have been discussed with particular reference to the examples illustrated. However, it will be appreciated that variations and modifications may be made to the examples described within the scope of the invention as defined by the appended claims. For example, it will be understood that two or more of the examples described hereinbefore may be combined and that, in some examples, the features of one example may be combined with the features of one or more other examples.

1. An energy storage system for a marine vessel, the energy storage system comprising:
a first fluid inlet to receive a first fluid from a first system of the marine vessel;
a second fluid outlet for supplying a second fluid to a second system of the marine vessel; and
a phase change material, having a melting temperature of greater than 0 C at atmospheric pressure, to receive and store heat energy from the first fluid received from the first system via the first fluid inlet and to supply the heat energy to the second fluid to be supplied to the second system via the second fluid outlet.

2. The energy storage system of claim 1, comprising a first fluid inlet valve for selectively opening and closing the first fluid inlet, and comprising a second fluid outlet valve for selectively opening and closing the second fluid outlet.

3. The energy storage system of claim 2, wherein the energy storage system is configurable in:
a first configuration, wherein the first fluid inlet is open and the second fluid outlet is closed; and
a second configuration, wherein the second fluid outlet is open and first fluid inlet is closed.

4. The energy storage system of claim 1, the energy storage system further comprising a chamber, wherein the first fluid inlet and the second fluid outlet are fluidically connected or connectable to the chamber.

5. The energy storage system of claim 1, the energy storage system further comprising a conduit through which a third fluid is flowable to transfer heat energy between the phase change material and one or both of the first and second fluids.

6. The energy storage system of claim 5, comprising a first heat exchanger comprising the first fluid inlet, a second heat exchanger comprising the second fluid inlet, and a fluid loop comprising the first heat exchanger, the second heat exchanger, and the conduit.

7. The energy storage system of claim 6, wherein the energy storage system comprises a fluid loop bypass valve for causing the third fluid to bypass the first heat exchanger, wherein when the fluid loop bypass valve is open, the third fluid is passed through the fluid loop without receiving heat from the first system via the first heat exchanger.

8. The energy storage system of claim 1, the energy storage system further comprising a phase change capsule, the phase change capsule comprising the phase change material and a heat exchange interface encapsulating the phase change material.

9. An energy storage device for a marine vessel, the energy storage device comprising:
a housing;
a first fluid inlet to receive a first fluid into the housing from a first system of the marine vessel;
a second fluid outlet for supplying a second fluid from the housing to a second system of the marine vessel; and
a phase change material in the housing to receive and store heat energy from the first fluid received into the housing via the first fluid inlet and to supply the heat energy to the second fluid to be supplied from the housing to the second system of the marine vessel via the second fluid outlet.

10. The energy storage device of claim 9, comprising a second fluid inlet to receive the second fluid into the housing from the second system of the marine vessel.

11. The energy storage device of claim 9, comprising a first fluid outlet to supply the first fluid from the housing to the first system of the marine vessel.

12. A hull for a marine vessel, the hull comprising at least one energy storage system according to claim 1.

13. A marine vessel comprising:
the energy storage system of claim 1; and
the first system and the second system.

14. A method of handling energy in a marine vessel, the method comprising:
storing, in a phase change material having a melting temperature of greater than 0 C at atmospheric pressure, heat energy from a first fluid from a first system of the marine vessel; and
supplying, to a second fluid for a second system of the marine vessel, the heat energy stored in the phase change material.

15. The method of claim 14, comprising:
receiving, in a housing in which is the phase change material, the first fluid from the first system of the marine vessel;
storing, in the phase change material, the heat energy from the first fluid; and
after the supplying, supplying the second fluid from the housing to the second system of the marine vessel.
